(19) United States
(12) Patent Application Publication
(10) Pub. No.: US 2023/0252086 A1
(43) Pub. Date: Aug. 10, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Shoko CHIBA, Kanagawa (JP); Motoyuki TAKAAI, Kanagawa (JP)

(73) Assignee: FUJIFILM Business Innovation Corp., Tokyo (JP)

(21) Appl. No.: 17/969,678

(22) Filed: Oct. 19, 2022

(30) Foreign Application Priority Data
Feb. 4, 2022 (JP) 2022-016055

(51) Int. Cl. G06F 16/9038; G06F 16/93

(52) U.S. Cl. CPC G06F 16/9038; G06F 16/93

(57) ABSTRACT

An information processing apparatus includes a processor configured to provide a user with information for assisting in search, in a case where candidates selected by the user from among plural candidates that are search results are displayed in order, in a case where a predetermined condition is established for a tendency related to plural operations of the user executed with respect to each search result.

### CROSS-REFERENCE TO RELATED APPLICATIONS

This application is based on and claims priority under 35 USC 119 from Japanese Patent Application No. 2022-016055 filed Feb. 4, 2022.

### BACKGROUND

### (i) Technical Field

The present invention relates to an information processing apparatus, a non-transitory computer readable medium storing a program, and an information processing method.

### (ii) Related Art

Some application programs (hereinafter also referred to as “software” or “applications”) have an assistant function that assists user's work. The assistant function is a kind of user interface, and estimates and provides information for assisting the user's operation through a display of characters or messages.

### SUMMARY

In recent years, from the viewpoint of technology succession, various business operators have been advancing the digitization and accumulation of know-how or experiences of a skilled person, and other personal information. In addition, various documents that are handled in daily work are accumulated in a user's terminal or storage on the network.

On the other hand, currently, utilization of accumulated documents for business does not meet the expectations of business operators or users. For example, users cannot find the document to be needed, and finding out requires a lot of trial and error.

Therefore, a consideration is made to use an assistant function that assists the user in searching for a document. However, current technology does not provide assistance at a timing at which a user needs assistance.

Aspects of non-limiting embodiments of the present disclosure relate to an information processing apparatus, a non-transitory computer readable medium storing a program, and an information processing method that improve the accuracy of a timing at which a user needs assistance as compared with a case where a timing of assistance is determined by focusing on a word used in a search.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to provide a user with information for assisting in search, in a case where candidates selected by the user from among a plurality of candidates that are search results are displayed in order, in a case where a predetermined condition is established for a tendency related to a plurality of operations of the user executed with respect to each search result.

### BRIEF DESCRIPTION OF THE DRAWINGS

Exemplary embodiment(s) of the present invention will be described in detail based on the following figures, wherein:

FIG. 1 is a diagram for describing an example of a configuration of an information processing system assumed in an exemplary embodiment;

FIG. 2 is a diagram for describing an example of a functional configuration of a terminal;

FIG. 3 is a flowchart for describing an example of processing executed by a terminal operated by a user who searches for an electronic document;

FIGS. 4A and 4B are diagrams for describing an example of information acquired related to a browsed page. FIG. 4A shows information acquired at a stage in a case where browsing of the first page is completed, and FIG. 4B shows information acquired at a stage in a case where browsing of the second page is completed;

FIG. 5 is a diagram for describing an example of information acquired related to browsed pages that are browsed during a series of searches;

FIG. 6 is a diagram for describing an example of calculation of moving averages and similarities between pages at a stage in a case where browsing up to the third page is completed;

FIG. 7 is a diagram for describing an example of calculation of moving averages and similarities between pages at a stage in a case where browsing up to the fourth page is completed;

FIG. 8 is a diagram for describing an example of calculation of moving averages and similarities between pages at a stage in a case where browsing up to the eighth page is completed;

FIG. 9 is a diagram for describing an example of information saved at the stage in a case where browsing up to the eighth page is completed;

FIG. 10 is diagram for describing a situation that satisfies a condition where information for assisting in search is provided;

A part (A) and a part (B) in FIG. 11 are diagrams for describing an example of processing of estimating a word that a user pays attention to. The part (A) in FIG. 11 shows an example of information used for estimating words in which a degree of attention is high, and the part (B) in FIG. 11 shows a list of candidates of words in which the degree of attention is high;

A part (A), a part (B), and a part (C) in FIG. 12 are diagrams for describing an example of processing performed until narrowing down a new search keyword. The part (A) in FIG. 12 shows a list of candidates of words in which the degree of attention is high, the part (B) in FIG. 12 shows a list of candidates of words sorted based on calculated scores, and the part (C) in FIG. 12 shows an example of recommended search keywords;

A part (A) and a part (B) in FIG. 13 are diagrams for describing a case where information for assisting a user is displayed on a screen on which search results are displayed. The part (A) in FIG. 13 shows an example of a screen used to display search results in a case where a determination is made that assistance is not needed, and the part (B) in FIG. 13 shows an example of a screen used to display search results in a case where a determination is made that assistance is needed;

FIG. 14 is a diagram for describing another example in a case where information for assisting a user is displayed on a screen on which search results are displayed; and

FIG. 15 is a diagram for describing still another example in a case where information for assisting a user is displayed on a screen on which search results are displayed.

### DETAILED DESCRIPTION

Hereinafter, exemplary embodiments of the present invention will be described with reference to the drawings.

Configuration of System

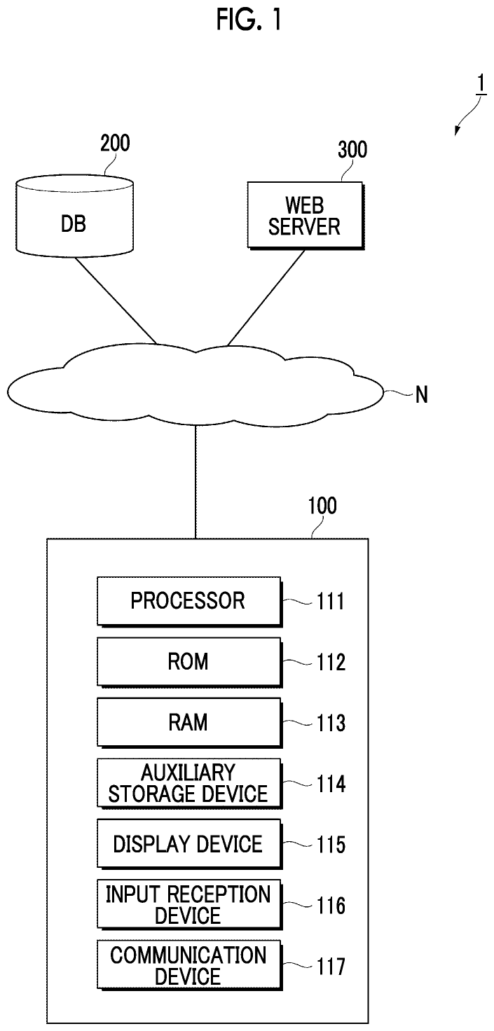

FIG. 1 is a diagram for describing an example of a configuration of an information processing system 1 assumed in an exemplary embodiment.

The information processing system 1 shown in FIG. 1 is configured to include a terminal 100, a database (hereinafter also referred to as a “DB”) 200, and a web server 300. The terminal 100, the DB 200, and the web server 300 are connected to a network N.

The network N may be a local area network (LAN) or the Internet. Further, the network N may be a 4G, a 5G, or other mobile communication system.

In a case of FIG. 1, although the terminal 100, the DB 200, and the web server 300 are present on the same network N, the network N may be configured with a plurality of networks.

The terminal 100 is a terminal used by a user to search for information. The terminal 100 is, for example, a desktop terminal, a laptop terminal, a tablet terminal, a smart phone, or smart glasses. The smart glasses is a device that display a virtual image in front of the user's line of sight.

The terminal 100 is an example of an information processing apparatus in the claims. Although one terminal 100 is depicted in FIG. 1, a plurality of terminals 100 may be used.

Further, in the example in FIG. 1, although an assumption is made that electronic documents to be searched is stored in the DB 200 and the web server 300, the electronic documents to be searched may be stored in the terminal 100. In that case, a system configuration of only the terminal 100 is also possible.

The electronic documents handled in the present exemplary embodiment include file data created by various applications, file data digitized from paper documents, and file data output from various electronic devices.

Examples of an application here include word processing software, spreadsheet software, presentation software, drawing software, database software, email software, groupware software, accounting software, computer aided design (CAD) software, desktop publishing (DTP) software, process management software, web production software, image editing software, and audio editing software.

Further, examples of the file data digitized from paper documents include scan data and facsimile data.

Examples of various electronic devices include a camera, a microphone, a scanner, a facsimile, and a medical device.

The electronic documents handled in the present exemplary embodiment are, for example, any one of a character, a static image, a motion picture, a voice, and data processed by a program.

In addition to data generated in daily business, data obtained by electronically recording the know-how or experiences of a skilled person, and other personal information are also included in the electronic documents. A skilled person mean a person who has a lot of experiences in various occupations and a person who has high business skills.

The terminal 100 includes a processor 111 that controls an entire operation of the device, a read only memory (ROM) 112 that stores a basic input output system (BIOS) and the like, a random access memory (RAM) 113 that is used as a work area for the processor 111, an auxiliary storage device 114, a display device 115, an input reception device 116 that receives an input of information by using a mouse or keyboard, and a communication device 117 that is used for communication with a network N.

The processor 111 and each device are connected through a signal line such as a bus.

The processor 111, the ROM 112, and the RAM 113 function as a so-called computer.

The processor 111 implements various functions through execution of a program. For example, the processor 111 executes processing or the like of providing information for assisting a user in search.

The auxiliary storage device 114 is, for example, a hard disk device or a semiconductor storage. The auxiliary storage device 114 is used to store an operating system (OS), an application, and other programs, searched data, and the like. The auxiliary storage device 114 may store a document to be searched.

The communication device 117 is a device that enables communication with other devices connected to the network N. A module conforming to Ethernet (registered trademark), WiFi (registered trademark), or any other communication standard are used for the communication device 117.

The database 200 is, for example, a hard disk device or semiconductor storage. The database 200 stores an electronic document to be searched. A storage may be used instead of the database 200 or together with the database 200.

Although one database 200 is depicted in FIG. 1, a plurality of databases 200 may be used.

The web server 300 is, for example, a server that includes a hard disk device or semiconductor storage. The web server 300 provides various services through a web browser executed on the terminal 100. One of the services is a search service. A file server may be used instead of the web server 300 or together with the web server 300.

Although one web server 300 is depicted in FIG. 1, a plurality of web servers 300 may be used.

Functional Configuration of Terminal

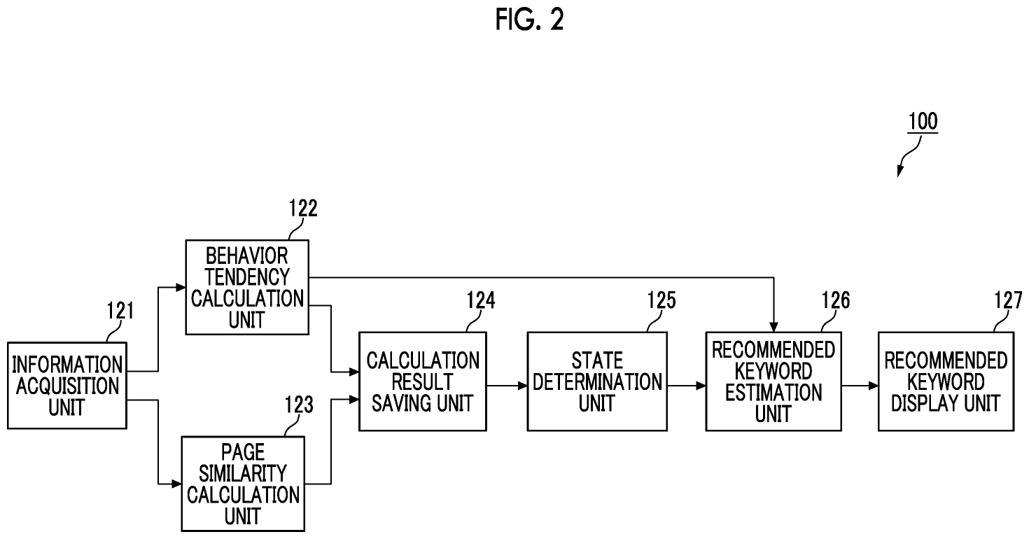

FIG. 2 is a diagram for describing an example of a functional configuration of the terminal 100.

Functions shown in FIG. 2 correspond to assistant functions for assisting in information searches, among various functions implemented through execution of a program.

As described above, a timing and the content of the assistance are important for the user assistance by using the assistant functions. In the present exemplary embodiment, users can efficiently search for information by increasing the accuracy of the timing.

An information acquisition unit 121 is a functional unit that acquires various types of information related to search.

An example of the information to be acquired includes information entered by a user for searching an electronic document. An example of one of the types of information input by the user includes a keyword (hereinafter referred to as a “search keyword”). In a case of the present exemplary embodiment, the search keyword is a character string. However, an image may be included in the information entered by the user for searching an electronic document.

In addition, the information entered by the user may include a search condition. An example of the search condition includes a condition that defines an electronic document. Examples of the condition that defines an electronic document include a type, a period, a language used for description, a creator, and the like.

Another example of the information to be acquired includes information related to an electronic document selected by the user from the results of the search (hereinafter also referred to as “search results” and “candidates”). In other words, there is information related to an electronic document that the user has selectively browsed.

In a case where the browsed electronic document is a web page, the information of the accessed web page is acquired. The web page is an electronic document written in a hypertext markup language (HTML). Examples of the information of the acquired web page include a page name, a page uniform resource locator (URL), a character string described in the page, an embedded link, and other information that can be acquired.

For other documents, information corresponding to the document type is acquired. For example, in a case where the browsed electronic document is an image, attribute data of the image or a feature quantity that is extracted from the image may be acquired.

Other examples of information to be acquired include information related to browsing candidates.

In a case where the browsed electronic document is a web page, examples of the information include date and time the relevant page is browsed, the length of time the page is browsed (hereinafter referred to as “browsing time”), the scroll speed of the page (hereinafter referred to as a “scroll speed”), a command entered by the user, coordinates where a cursor is positioned, a character string where the cursor is positioned, time the cursor is positioned on the character string (hereinafter referred to as “stay time”), and other information that can be acquired.

These types of information are an example of information about user behaviors during browsing.

A behavior tendency calculation unit 122 is a functional unit that calculates a tendency of operations (hereinafter also referred to as a “behavior tendency”) from the information related to the browsing candidates. An example of the behavior tendency includes a moving average of time required to browse the presented candidates one after another (hereinafter referred to as “browsing time”). In the present exemplary embodiment, the moving average is calculated as an average value of the browsing times of the three candidates that are previously browsed. In other words, the browsing time per one candidate is calculated for each of the three candidates.

In a case where the candidates being browsed is far from the electronic document needed by the user, the moving average of the browsing time tends to be small. The reason is that the user browses different candidates one after another.

On the other hand, in a case where the candidates being browsed is close to the electronic document needed by the user, the moving average of the browsing time tends to be large. The reason is that the content checking time takes long.

However, the number of candidates used for calculating the moving average is not limited to three. For example, the moving average may be calculated using the four candidates that are previously browsed as a unit. In addition, as the behavior tendency, for example, a moving average of scroll speed may be calculated.

A page similarity calculation unit 123 is a functional unit that calculates a similarity between two candidates before and after the user browsed. The similarity is calculated based on the information related to the selected candidates. A known technology is used to calculate the similarity. For example, electronic documents are vectorized and a cosine similarity between two vectors is calculated.

In the present exemplary embodiment, an assumption is made that the candidate is a web page, so the calculated similarity is called as a “page similarity”. In a case of the present exemplary embodiment, the page similarity is calculated based on a feature quantity of the browsed web page and a feature quantity of another web page that is previously browsed. The feature quantity is represented as a vector, for example.

A calculation result saving unit 124 is a functional unit that saves the information acquired by the information acquisition unit 121, the moving average calculated by the behavior tendency calculation unit 122, and the similarity calculated by the page similarity calculation unit 123 in the auxiliary storage device 114 or the like.

A state determination unit 125 determines whether or not assistance is needed based on a slope of the transition of the moving average calculated by the behavior tendency calculation unit 122 and a slope of the transition of the similarity calculated by the page similarity calculation unit 123. The state in which assistance is needed is a state in which the user is “in trouble”.

In a case of the present exemplary embodiment, the state determination unit 125 determines that assistance is needed in a case where the following two conditions are satisfied. The two conditions here are an example of a “predetermined condition” in the scope of claims. Further, the fact that two conditions are satisfied at the same time represents that the predetermined condition is established.

The first condition is that a slope of transition of the moving average that is calculated with respect to the browsing candidates is described as “continuous with a negative slope” between two search keywords.

The second condition is that a slope of the similarity is described as “continuous with a positive slope” between the two search keywords.

A recommended keyword estimation unit 126 is a functional unit that estimates a word in which the user pays attention to from the information related to the browsing candidates.

The information related to the browsing candidates is provided from the behavior tendency calculation unit 122. The estimation here also takes into account the amount of time elapsed from the time when browsing of a page is completed until the time when a state in which assistance is needed is detected.

The recommended keyword estimation unit 126 in the present exemplary embodiment estimates candidates of words in which a degree of attention is high by the user by using coordinates where a cursor is positioned, a character string where the cursor is positioned, and the time the cursor is positioned on the character string (that is the stay time).

Specifically, the recommended keyword estimation unit 126 multiplies the stay time of the cursor by the reciprocal of the amount of time elapsed from the time when browsing of the page that includes each candidate is completed until the time when a state in which assistance is needed is detected, and specifies the candidates with the highest degree of attention for the user.

The recommended keyword estimation unit 126 outputs the specified candidate as a keyword to be recommended (hereinafter also referred to as a “recommended keyword”).

A recommended keyword display unit 127 is a functional unit that displays the recommended keyword on the display device 115 (see FIG. 1).

Operation of Processing

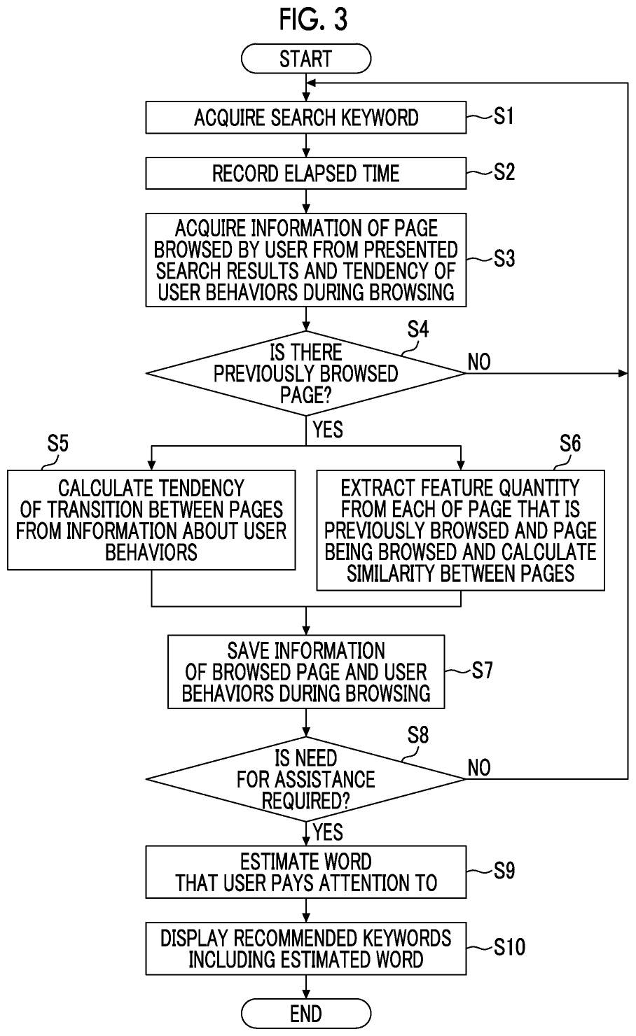

The following describes an operation of processing that is executed in connection with searching for an electronic document with reference to FIGS. 3 to 15.

FIG. 3 is a flowchart for describing an example of processing executed by the terminal 100 (see FIG. 1) operated by a user who searches for an electronic document.

The symbol “S” represents a step in the figure. The processing shown in FIG. 3 is implemented through a program execution by the processor 111 (see FIG. 1). The program is being running and monitors user search.

First, the processor 111 acquires a search keyword (step S1). The execution of the search is executed by a search engine (not shown). In a case of the present exemplary embodiment, the search engine is present in the database 200 or the web server 300, for example. The search keyword is acquired each time a browsing target is designated from the list of the search results.

Next, the processor 111 records the elapsed time since the start of the search (step S2). The start of the search is started by inputting a first search keyword, for example. The browsing time for each page is measured separately from the elapsed time.

Subsequently, the processor 111 acquires the information of the page browsed by the user from the presented search results and a tendency of the user behaviors during browsing (step S3).

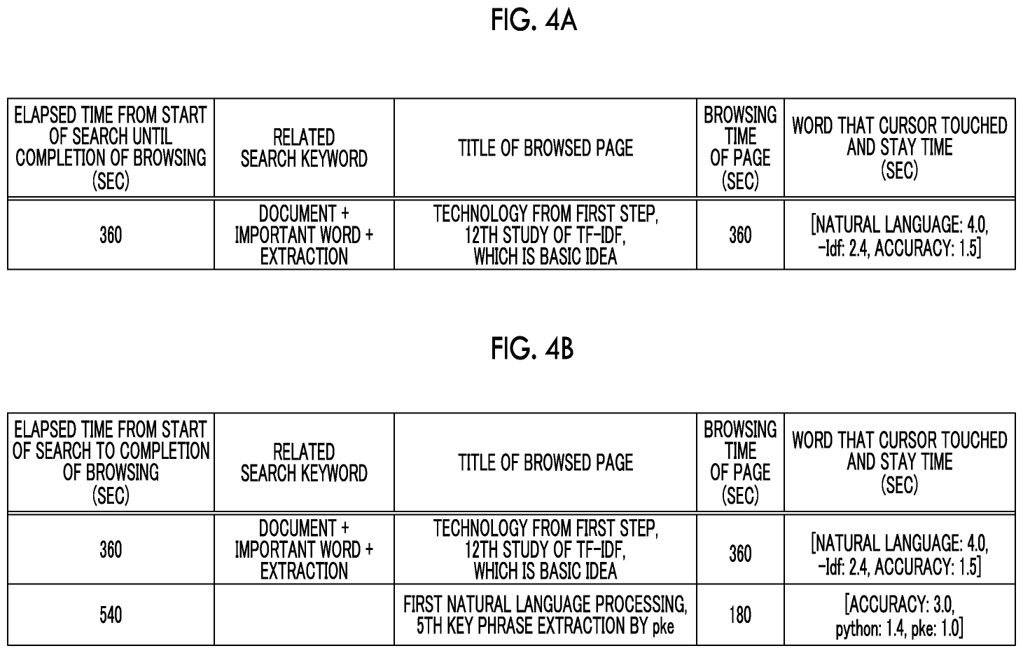

FIGS. 4A and 4B are diagrams for describing an example of information acquired related to a browsed page. FIG. 4A shows information acquired at a stage in a case where browsing of the first page is completed, and FIG. 4B shows information acquired at a stage in a case where browsing of the second page is completed;

Each row corresponds to a browsed page and each column corresponds to acquired information.

As shown in FIGS. 4A and 4B, each time a new page is browsed, information related to “elapsed time from start of search to completion of browsing (sec)”, a “related search keyword”, a “title of browsed page”, “browsing time of page (sec)”, and “a word that the cursor touched and stay time (sec)” are acquired and recorded.

A search that uses “document+important word+extraction” as search keywords is an example of a first search.

Further, all of the operation of selecting a page to browse, the selected browsing time of the page, and the word that the cursor touched and stay time in the selection page, from the search results with the search keywords of “document+important word+extraction”, are examples of a first operation.

The title of the first browsed page is “Technology from the first step, 12th study of TF-IDF, which is the basic idea”. The page is the result of the search using “document+important word+extraction” as the search keywords. Further, the browsing time of the first browsed page is 360 seconds.

In the case in FIG. 4A, the elapsed time from the start of search to the completion of browsing is the same as the browsing time, but there is actually a discrepancy.

Further, the word and the stay time that the user touched with the cursor during browsing of the first page are recorded. In FIG. 4A, three words are listed in descending order of the stay time. Incidentally, the stay time for “natural language” is 4 seconds, the stay time for “−Idf” is 2.4 seconds, and the stay time for “accuracy” is 1.5 seconds.

The title of the second browsed page is “First natural language processing, 5th Key phrase extraction by pke”. The page is also the result of the search using “document+important word+extraction” as the search keywords. The browsing time of the second browsed page is 180 seconds. As for the words and the stay times that the cursor touched in the second browsed page, “accuracy” is 3 seconds, “python” is 1.4 seconds, and “pke” is 1 second.

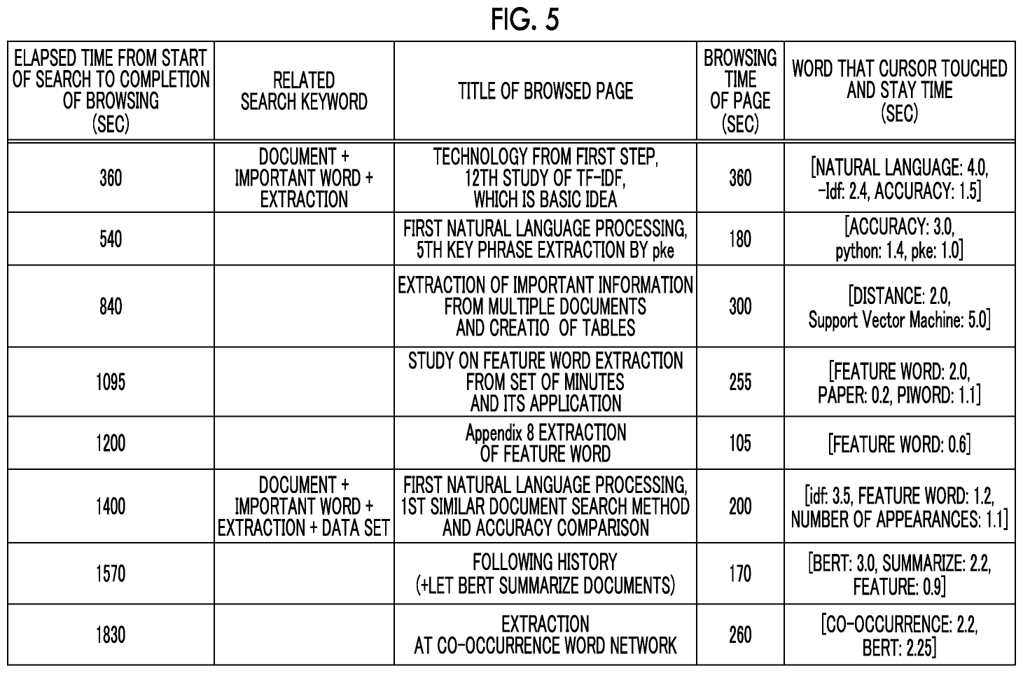

FIG. 5 is a diagram for describing an example of information acquired related to browsed pages that are browsed during a series of searches. FIG. 5 describes information acquired from eight pages including six newly browsed pages.

Incidentally, the browsing time of the third row page (that is, the page browsed thirdly) is 300 seconds, the browsing time of the fourth row page (that is, the page browsed fourthly) is 255 seconds, and the browsing time of the fifth row page (that is, the page browsed fifthly) is 105 seconds. The search keywords are the same for the pages from the first row to the fifth row.

In the first column of “elapsed time from start of search to completion of browsing (sec)”, the total browsing time of each page is recorded. Therefore, the elapsed time to the completion of browsing the second row page (that is, the page browsed secondly) is 540 seconds (=360 seconds+180 seconds).

In the case in FIG. 5, the search keywords are switched from the sixth row page (that is, the page browsed sixthly). Specifically, the search keywords are changed to “document+important word+extraction+data set”.

A search that uses “document+important word+extraction+data set” as search keywords is an example of a second search.

Further, all of the operation of selecting a page to browse, the selected “browsing time of page (sec)”, and the “word that the cursor touched and stay time (sec)” in the selection page, from the search results with the search keywords of “document+important word+extraction+data set”, are examples of a second operation.

However, in the first column of “elapsed time from start of search to completion of browsing”, the elapsed time, which is calculated regardless of the difference in search keywords, is recorded.

Referring back to FIG. 3.

In a case where the information related to the newly browsed page is acquired, the processor 111 determines whether or not there is a page that is previously browsed for the same search keyword (step S4).

In a case where there is a page that is previously browsed, the processor 111 obtains a positive result in step S4. For example, in the case in FIG. 5, the second row page to fifth row page and the seventh row page and eighth row page correspond to the above result.

On the other hand, in a case where there is no page that is previously browsed, the processor 111 obtains a negative result in step S4. For example, in the case in FIG. 5, the first row page and the sixth row page correspond to the above result.

In a case where a negative result is obtained in step S4, the processor 111 returns to step S1 and waits for the user to browse another page.

In a case where a positive result is obtained in step S4, the processor 111 executes processing (step S5) of calculating a tendency of the transition between pages from the information about the user behaviors, and processing (step S6) of extracting a feature quantity from each of the page that is previously browsed and the page being browsed and calculating the similarity between the pages.

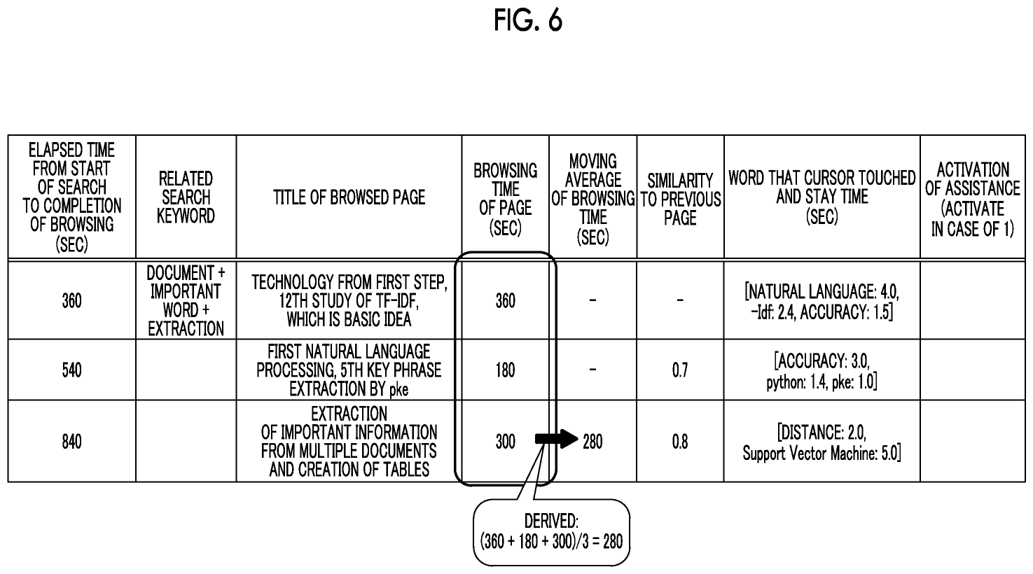

FIG. 6 is a diagram for describing an example of calculation of moving averages and similarities between pages at a stage in a case where browsing up to the third page is completed. The diagram shown in FIG. 6 includes additional items of “moving average of browsing time (sec)”, “similarity to previous page”, and “activation of assistance”.

FIG. 6 shows an example of calculation of a moving average obtained from the first row page (that is, the page browsed firstly) to the third row page (that is, the page browsed thirdly). In the case in FIG. 6, the moving average is 280 (=(360+180+300)/3).

The similarity between the page browsed firstly and the page browsed secondly is 0.7, and the similarity between the page browsed secondly and the page browsed thirdly is 0.8.

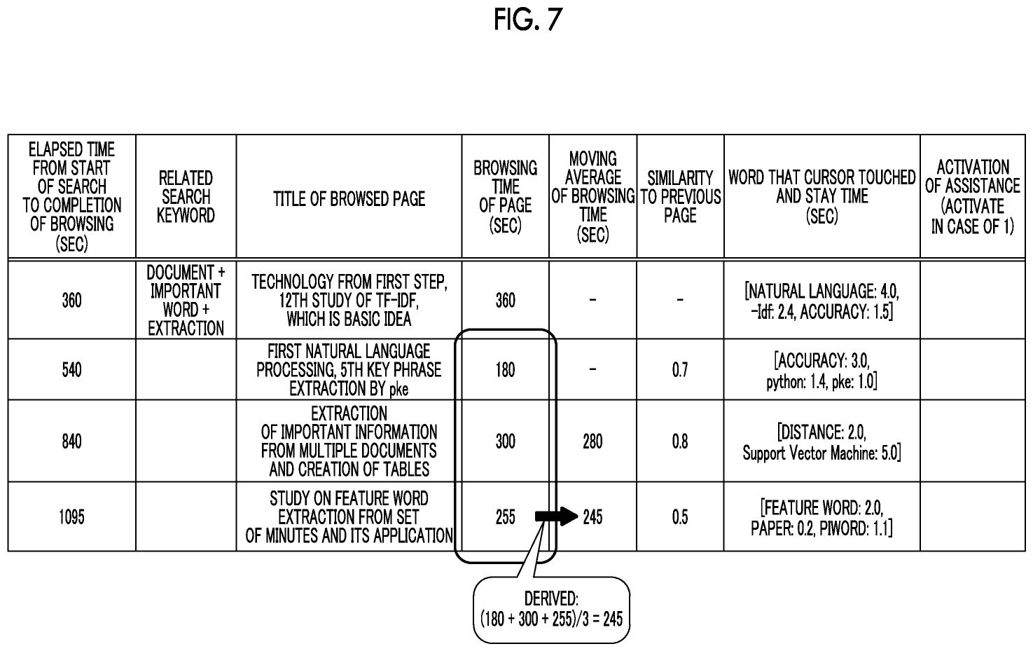

FIG. 7 is a diagram for describing an example of calculation of moving averages and similarities between pages at a stage in a case where browsing up to the fourth page is completed. The case in FIG. 7 shows an example of calculation of a moving average obtained from the second row page (that is, the page browsed secondly) to the fourth row page (that is, the page browsed fourthly). In the case in FIG. 7, the moving average is 245 (=(180+300+255)/3).

The similarity between the page browsed thirdly and the page browsed fourthly is 0.5.

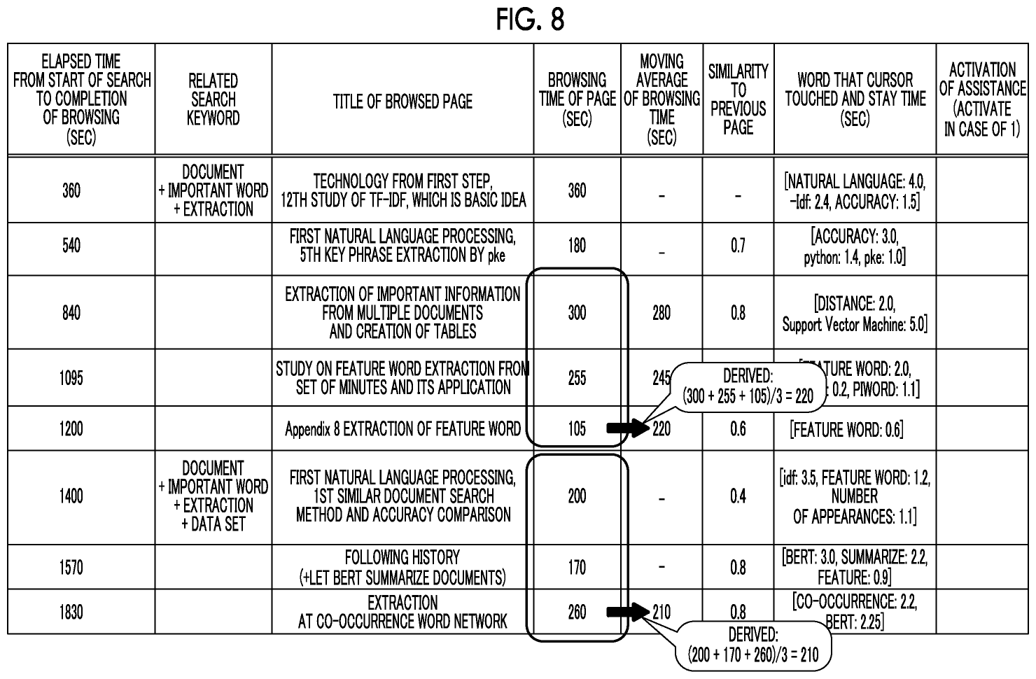

FIG. 8 is a diagram for describing an example of calculation of moving averages and similarities between pages at a stage in a case where browsing up to the eighth page is completed. In the case in FIG. 8, the search keywords are switched from the sixth row page (that is, the page browsed sixthly). Therefore, as the moving average among the 3 pages including the fifth row page (that is the page browsed fifthly), 220 (=300+255+105)/3) is calculated, and then the moving average fields in the following two rows are blank. The moving average from the sixth row to eighth row pages is 210 (=200+170+260)/3).

Note that, the similarity between pages is calculated before and after switching of the search keywords. Therefore, the similarity between the page browsed fifthly and the page browsed sixthly is 0.4. In the example in FIG. 8, “data set” is added as a new search keyword, but the similarity with the page browsed fifthly is decreased.

Incidentally, the similarity between the page browsed sixthly and the page browsed seventhly is 0.8, and the similarity between the page browsed seventhly and the page browsed eighthly is 0.8.

Referring back to FIG. 3.

After steps S5 and S6 are executed, the processor 111 saves the information of the browsed page and the user behaviors during browsing (step S7).

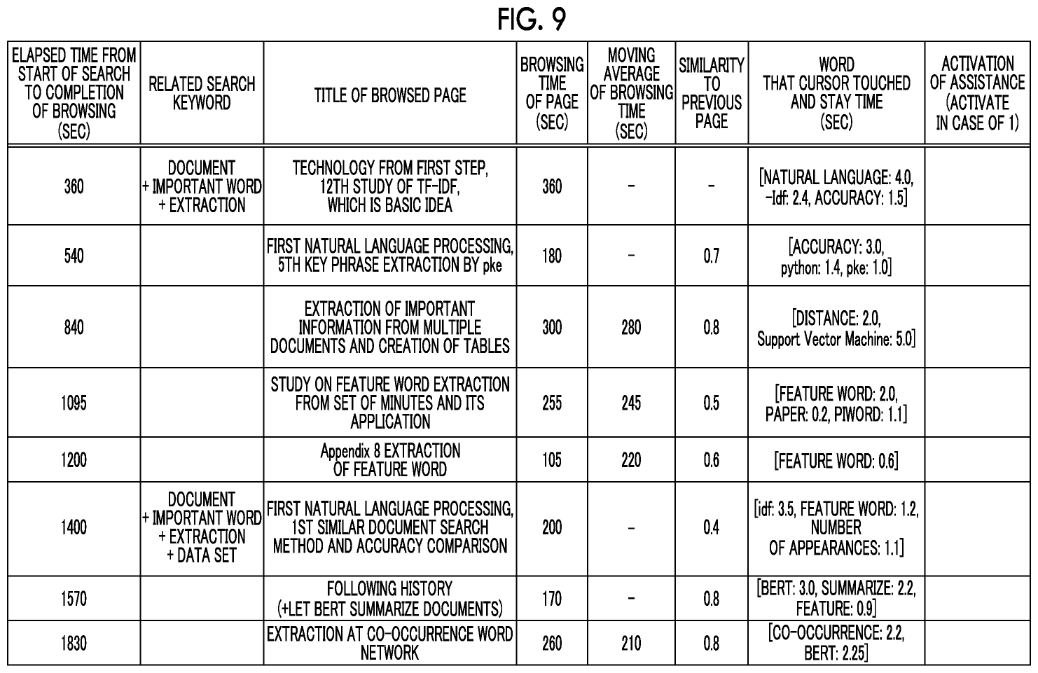

FIG. 9 is a diagram for describing an example of information saved at the stage in a case where browsing up to the eighth page is completed.

Next, the processor 111 determines whether or not the need for assistance is required (step S8). The determination in step S8 corresponds to the processing of the state determination unit 125 (see FIG. 2).

In a case where a determination is made that the need for assistance is required, the processor 111 obtains a positive result in step S8. In a case where a determination is made that the need for assistance is not required, the processor 111 obtains a negative result in step S8. In a case where a negative result is obtained in step S8, the processor 111 returns to step S1 and prepares the next browsing.

A situation that the assistance is needed represents that the user is in trouble.

In the case of the present exemplary embodiment, in a case where a tendency of high frequency of transition between pages by the user is detected, or a situation in which the similarity between browsed pages continues to be high is regarded as a situation in which the search by the user is not successful, that is, a situation in which the user is in trouble.

The high frequency of transitions is considered to be a situation in which page transitions occur because the target information is not obtained. Further, page browsing continues with a high similarity is considered to be a situation in which new information is not obtained.

In the present exemplary embodiment, a situation in which page browsing continues at a high frequency of transition and with high similarity, is determined as a situation in which the user assistance is needed.

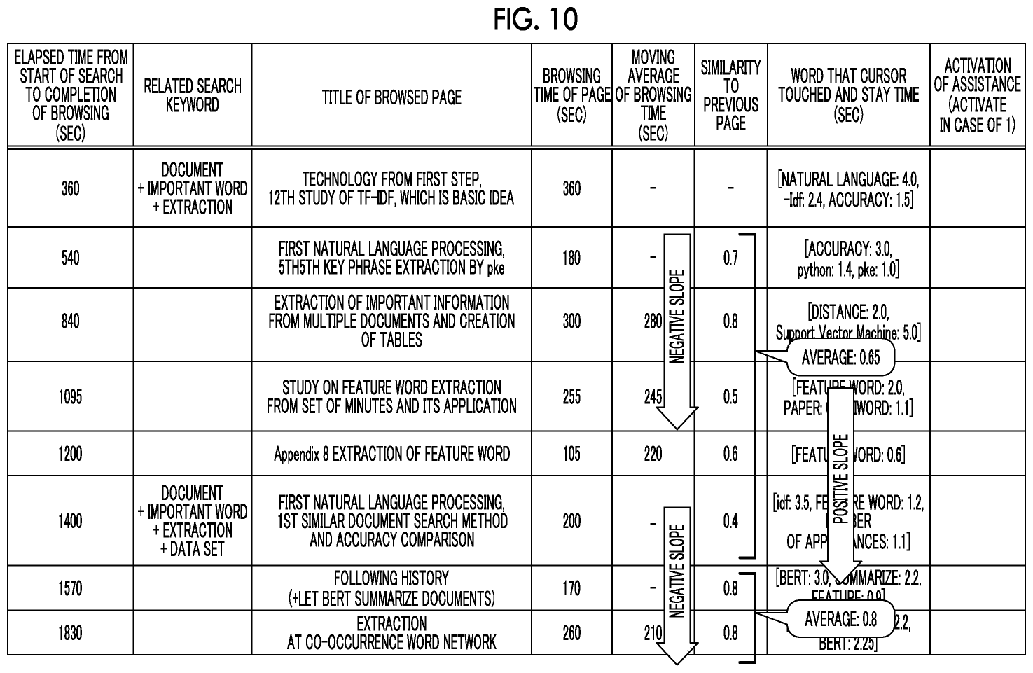

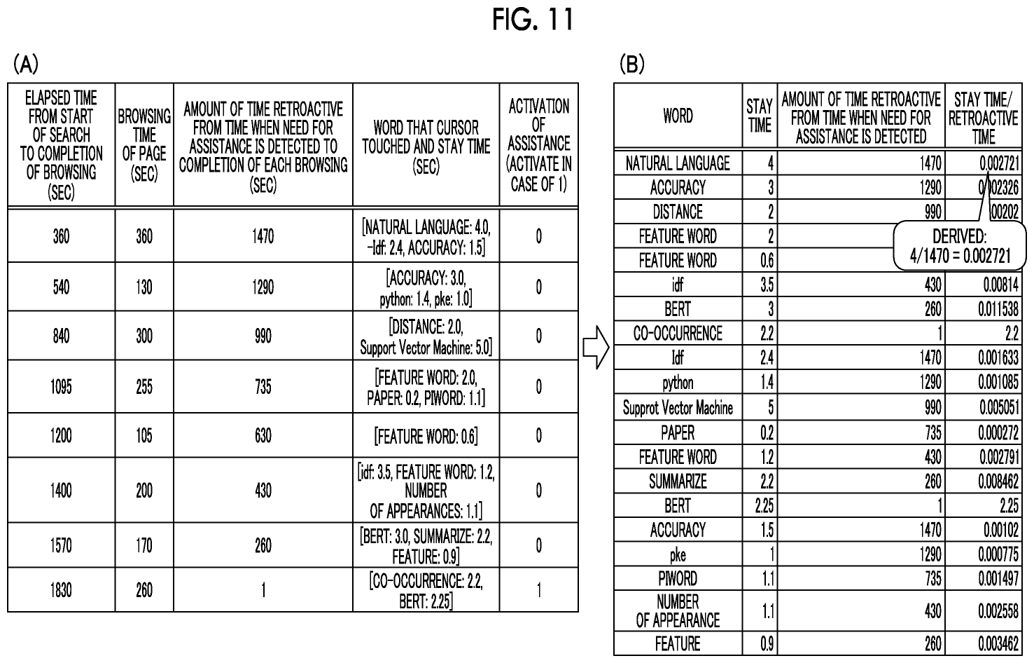

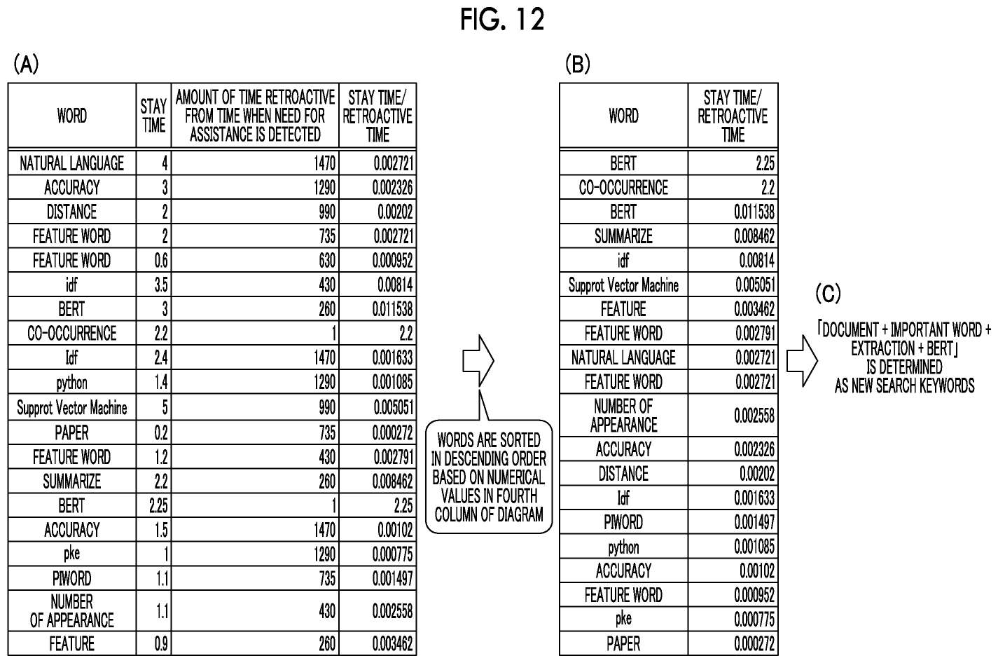

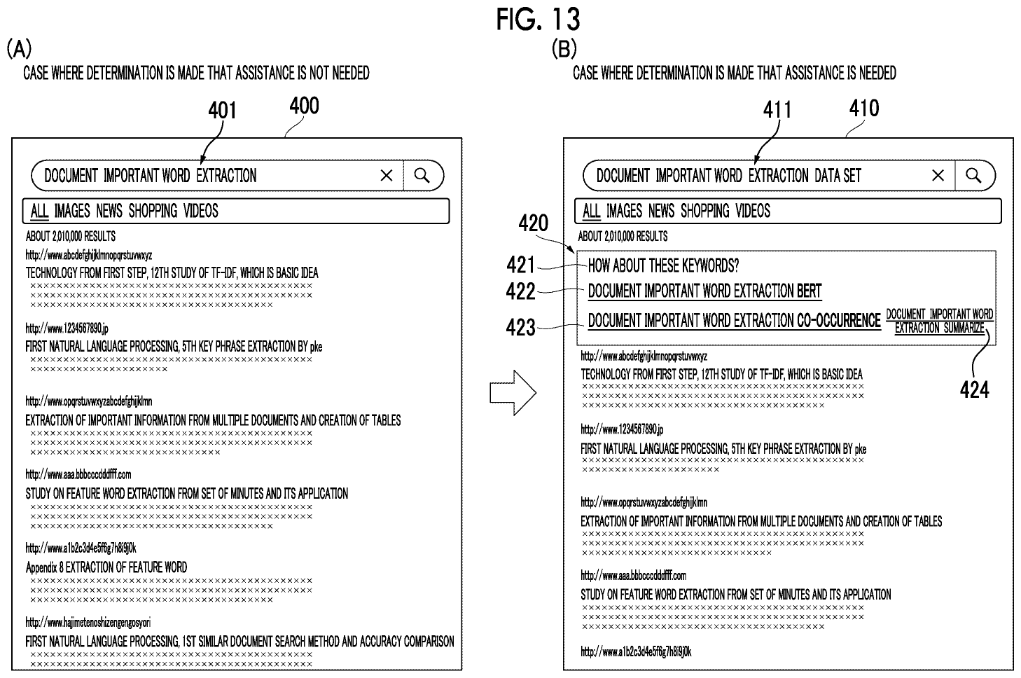

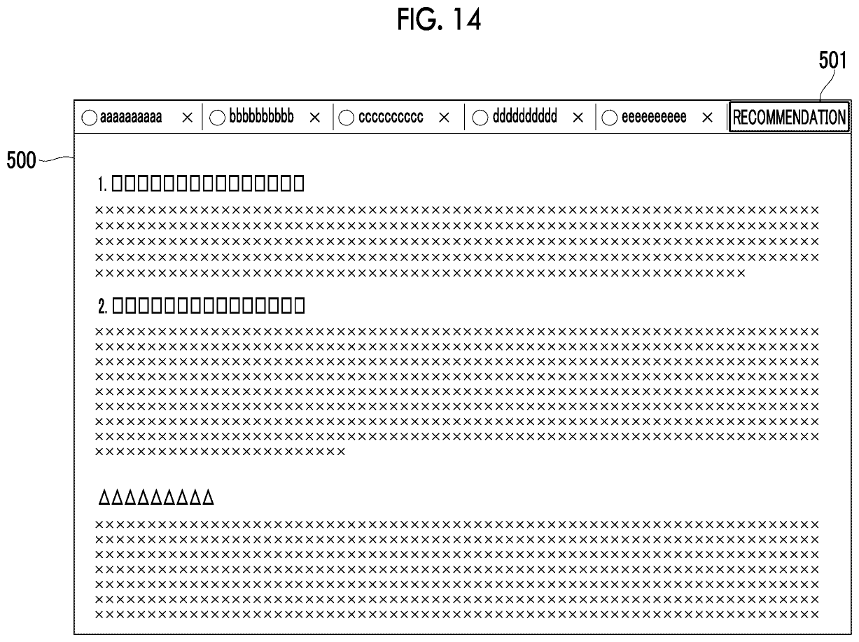

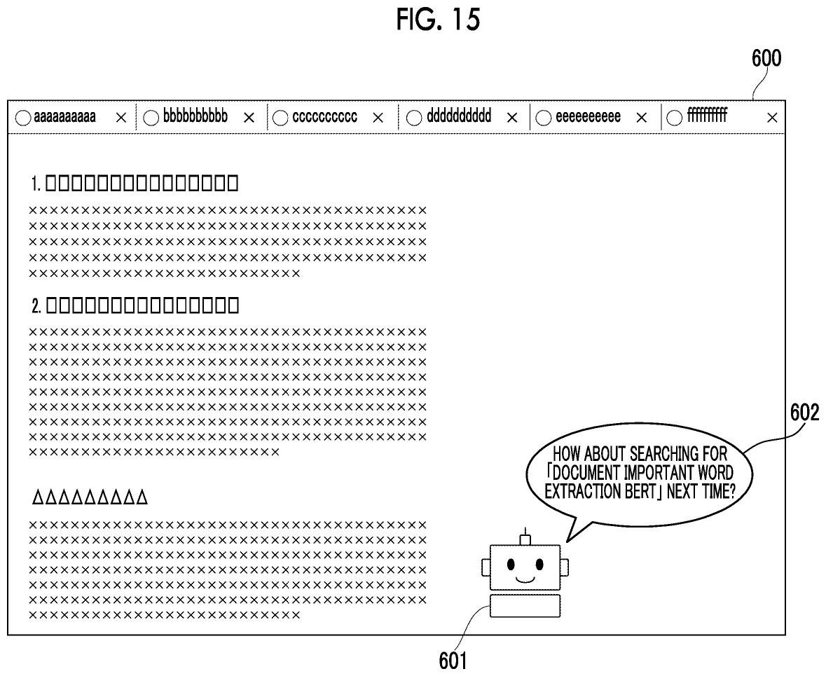

FIG. 10 is diagram for describing a situation that satisfies a condition where information for assisting in search is provided. Here, using FIG. 10, the description will be made that the condition, which is related to the need for assistance, is satisfied at the stage in a case where browsing the eighth row page (that is, the page browsed eighthly) is completed.

First, a situation in which page transitions continue at a high frequency will be described.

The moving average of the browsing time with respect to the first search keywords gradually decreased from 280 seconds to 245 seconds to 220 seconds. That is, a negative slope is recognized.

One moving average of the browsing time with respect to the second search keywords is recorded, that is 210 seconds. The moving average (that is, 210 seconds) here is smaller than the moving average (that is, 220 seconds) of the browsing time last calculated with respect to the first search keywords, and the negative slope continues.

The above state satisfies that the slope of the transition of the moving average of the browsing time is “continuous with a negative slope” between the two search keywords.

Next, a situation, in which page browsing continues with a high similarity even after the search keywords are changed, will be described.

The similarities between the browsed page with the previous browsed page for the first search keywords change as 0.7→0.8→0.5→0.6→0.4. An average value of the above is 0.65.

The similarities between the browsed page with the previous browsed page for the second search keywords change as 0.8→0.8. Incidentally, the first similarity is a similarity with the last browsed page with respect to the first search keywords. An average value of the above is 0.8.

In FIG. 10, the average value is calculated at a time point when two pages are browsed, but in a case where the minimum number of pages for which the average value is calculated is 3 pages or more, the average value can be calculated after browsing of three or more pages is completed.

The above state satisfies that the slope of the similarity is “continuous with a positive slope” between the two search keywords.

Referring back to FIG. 3.

In a case where a positive result is obtained in step S8, the processor 111 estimates a word that the user pays attention to (step S9). The estimated word is provided to the user as the information for assisting the user.

Regarding the word here, the word with a high degree of attention of the user is estimated from the movement or the like of the cursor during browsing. The words included in the search keywords are excluded from an estimation target.

A part (A) and a part (B) in FIG. 11 are diagrams for describing an example of processing of estimating a word that the user pays attention to. The part (A) in FIG. 11 shows an example of information used for estimating words in which the high degree of attention is high, and the part (B) in FIG. 11 shows a list of candidates of words in which the degree of attention is high.

In the diagram shown in the part (A) in FIG. 11, each row corresponds to the browsed page, and each column corresponds to the information used for estimation with high degree of attention.

In the case of the part (A) in FIG. 11, the first column is the “elapsed time from start of search to completion of browsing”, the second column is the “browsing time of page (sec)”, the third column is the “amount of time retroactive from time when need for assistance is detected to completion of each browsing (sec)”, the fourth column is the “word that the cursor touched and stay time (sec)”, and the fifth column is the “activation of assistance”.

The information in the third column of the part (A) in FIG. 11 is new information. The time, when the need for assistance is detected in the information in the third column, is the time when browsing, where a positive result is obtained in step S8 (see FIG. 3), is completed. In other words, the time, when the need for assistance is detected, is the time when the browsing of the page where the need for assistance is detected is completed.

This information, in other words, the time corresponds to the amount of time elapsed from the time when the cursor left each page until the time when browsing of the page where the need for assistance is detected is completed. Therefore, the earlier the page is browsed, the larger the time value recorded in the third column.

In the case of the present exemplary embodiment, the time when the browsing of the eighth row page where the need for assistance is detected is completed is 1830 seconds after the start of the search.

Therefore, the time in the third column for the first row page is calculated as 1470 seconds (=1830 seconds−360 seconds).

Similarly, the time in the third column for the second row page is calculated as 1290 seconds (=1830 seconds−540 seconds).

The time here is an example of the “amount of time elapsed from the time the cursor left the document containing the word until the predetermined condition is established”.

In the diagram shown in the part (B) in FIG. 11, each row corresponds to a word that the cursor touched on each page, and each column corresponds to information used for evaluating the level of the degree of attention of each word.

In the case of the part (B) in FIG. 11, the first column is a “word”, the second column is the “stay time” of the cursor, the third column is the “amount of time retroactive from time when need for assistance is detected”, and the fourth column is the “stay time/retroactive time”.

In the diagram shown in the part (B) in FIG. 11, the words recorded in the fourth column in the part (A) in FIG. 11 are sorted in order of stay time.

For example, the “stay time” of the “natural language”, which is extracted from the first page, is 4 seconds, the “amount of time retroactive from time when need for assistance is detected” is 1470 seconds, and the “stay time/retroactive time” is 0.002721 (=4/1470).

In a case where the stay time of the word is the same, a numerical value in the fourth column becomes large in a case where the word is present on a page closer to the time when the need for assistance is detected, and in a case where the word is on the same page, the numerical value in the fourth column becomes large in a case where the stay time is longer.

A part (A), a part (B), and a part (C) in FIG. 12 are diagrams for describing an example of processing performed until narrowing down a new search keyword. The part (A) in FIG. 12 shows a list of candidates of words in which the degree of attention is high, the part (B) in FIG. 12 shows a list of candidates of words sorted based on calculated scores, and the part (C) in FIG. 12 shows an example of recommended search keywords.

The diagram shown in the part (A) in FIG. 12 is the same as the diagram shown in the part (B) in FIG. 11.

The part (B) in FIG. 12 is a diagram in which words are sorted in descending order based on the numerical values in the fourth column of the diagram shown in the part (A) in FIG. 12. In the case of the part (B) in FIG. 12, “BERT”, in which the user paid attention when browsing the seventh page, is at the top place. The numerical value corresponding to “BERT” is 2.25. The second place is “co-occurrence”, in which the user paid attention when browsing the eighth page.

In the part (C) in FIG. 12, “document+important word+extraction+BERT” is determined as new search keywords by adding “BERT”, which is the top place, to the first search keyword.

Referring back to FIG. 3.

In a case where the estimation of the word that the user pays attention to is completed, the processor 111 displays the recommended keywords containing the estimated word (step S10).

An example of a screen used for the user assistance will be described below with reference to a part (A) and a part (B) in FIG. 13 to FIG. 15.

The part (A) and the part (B) in FIG. 13 are diagrams for describing a case where information for assisting the user is displayed on a screen on which search results are displayed. The part (A) in FIG. 13 shows an example of a screen 400 used to display search results in a case where a determination is made that assistance is not needed, and the part (B) in FIG. 13 shows an example of a screen 410 used to display search results in a case where a determination is made that assistance is needed.

The screen 400 shown in the part (A) in FIG. 13 is a screen that displays search results with respect to the first search keyword. Therefore, “document important word extraction” is displayed in an input field 401 of the search keyword on the first row of the screen 400, and below that, a list of titles and URLs of web pages, which are the search results, is displayed.

The screen 410 shown in the part (B) in FIG. 13 is a screen that appears in a case where a determination is made that the assistance is needed while the search results with respect to the second search keyword are being displayed. Therefore, “document important word extraction data set” is displayed in an input field 411 of the search keyword on the first row of the screen 410.

The initial screen in a case where the search results of the second search keyword is displayed is the same as the screen of the part (A) in FIG. 13.

However, based on the user's browsing behaviors, an assistance field 420 is inserted in a space between the input field 411 of the search keyword and the search results, on the screen 410 displayed at a time point when the determination is made that the user assistance is needed.

The assistance field 420 shown in the part (B) in FIG. 13 includes a description sentence 421 and recommended keywords 422 to 424.

The description sentence 421 includes, for example, “How about these keywords?”, which expresses that the content of the assistance field 420 shows the presentation of the new search keywords to the user.

The assistance field 420 shows three sets of recommended keywords.

The recommended keywords 422 where the priority order is the top place and the recommended keywords 423 where the priority order is the second place are displayed in a large font, and the recommended keywords 424 where the priority order is the third place is displayed in a small font. Note that the recommended keywords 422 to 424 are all displayed with hyperlinks.

The recommended keywords 422 where the priority order is the top place is “document important word extraction BERT”, the recommended keywords 423 where the priority order is the second place is “document important word extraction co-occurrence”, and the recommended keywords 424 where the priority order is the third place is “document important word extraction summary”.

In the part (B) in FIG. 13, the words recommended by the system are represented in bold characters.

In the diagram shown in the part (B) in FIG. 12, the word with the third largest numerical value is “BERT”, but since the “BERT” has already been presented as the recommended keywords 422 ranked top, the fourth place “summary” is moved up and included in the third place recommended keywords 424 in the diagram.

Hyperlinks are set up in each of the recommended keywords 422 to 424, so in a case where the user clicks on one of the search keywords, the screen 410 switches the screen to a list of corresponding search results. Therefore, the user can acquire new search results with just a click.

Instead of recommending the recommended keywords 422 to 424, only the recommended words can be presented on the screen. Also in this case, for example, a hyperlink is desirably associated with a search result screen in which the words recommended in the first search keywords are combined.

In addition, the priority order of recommended keywords can be represented by different font colors. For example, the recommended keyword 422 where the priority order is the top place may be represented by gold, the recommended keyword 423 where the priority order is the second place may be represented by silver, and the recommended keyword 424 where the priority order is the third place may be represented by bronze.

Further, the priority order of recommended keywords may be represented by numbers or symbols.

FIG. 14 is a diagram for describing another example in a case where information for assisting the user is displayed on a screen on which search results are displayed.

A new tab 501 is added to the upper right of a screen 500 shown in FIG. 14 to display search results based on the recommended keywords. Incidentally, the tab 501 is labeled with a word “recommendation”. The additional display of tab 501 is useful for calling attention to the user.

Further, in order to make the display of the tab 501 noticeable, the tab 501 may be displayed in a form different from the other tabs. For example, the font of the word used to display the tab may be changed, and the color of the tab may be changed.

At the same time when the tab 501 is added, the content displayed on the screen 500 may be forcibly switched to the content of the new tab.

Incidentally, a function of displaying the tab 501 on the screen 500 shown in FIG. 14 may be implemented as an extended function (that is, an add-on) of the web browser.

FIG. 15 is a diagram for describing another example in a case where information for assisting the user is displayed on a screen on which search results are displayed.

In a case where the determination is made that the user assistance is needed, an assistant 601 and an advice 602 are displayed on a screen 600 shown in FIG. 15.

In the case in FIG. 15, although the assistant 601 is an image of a robot, any image can be used for the assistant. Further, the image of the assistant can be preset by the user. In the case in FIG. 15, “How about searching for “document important word extraction BERT” next time?” is displayed as the advice 602. Any text can be used for the advice 602, and the text of the advice 602 may include a plurality of sets of search keywords, similar to the assistance field 420 (see the part (B) in FIG. 13).

### Summary

In the case of the present exemplary embodiment, the processor 111 (see FIG. 1) of the terminal 100 (see FIG. 1), on which the user executes the search, causes the screen 420 (see the part (B) in FIG. 13), the tab 501 (see FIG. 14), and the advice 602 (see FIG. 15) for assisting in search to appear on the screen only in a case where the search results that the user expects are not obtained.

Specifically, even after a different search keyword is input, the processor 111 detects that the following two conditions are satisfied, and displays a screen 420 or the like for assisting in search.

(1) The tendency for the moving average of browsing time to shorten continues while browsing the second search results in the same way as when browsing the first search results.

(2) A state in which a similarity between pages is high continues while browsing the second search results in the same way as when browsing the first search results.

Since the screen 420 or the like for assisting in search is displayed under the condition that the above conditions are satisfied, the user can easily accept assistance from the system side without hindering the user's operation.

Further, since an expectation can be made that the user's dissatisfaction with the display of information for assisting in search will be alleviated, a function of providing information for assisting in search is not invalidated by user settings.

Further, in the present exemplary embodiment, a technique is adopted in which the longer the stay time of the cursor on the recommended word, and the shorter the elapsed time until the need for assistance is detected, the higher the priority order of words to be candidates.

Therefore, the possibility may be high that an electronic document, in which the user pays attention to, is included in the search results based on the recommended new search keywords. As a result, an improvement in user satisfaction is expected. Further, the function of providing information for assisting in search is not invalidated by user settings.

### Other Exemplary Embodiments

(1) Although the exemplary embodiment of the present invention has been described above, the technical scope of the exemplary embodiment of the present invention is not limited to the scope described in the exemplary embodiment described above. The fact that the various modifications or improvements to the exemplary embodiment described above are also included in the technical scope of the exemplary embodiment of the present invention, is clearly stated in the claims.

(2) In the above-described exemplary embodiments, as one of the conditions for outputting information for assisting in search, the average value of similarity between browsed pages increases even after the search keywords are changed, that is the average value has a positive slope, is required, but other conditions may be adopted.

For example, both the average value of similarities corresponding to the first search and the average value of the similarities corresponding to the second search exceed a predetermined threshold value, may be required. The threshold value here is, for example, 0.6. In this case, the transition of the similarity in the sixth column in FIG. 10 also satisfies the condition related to the similarity.

(3) In the above-described exemplary embodiment, although an assumption is made that a case of searching and browsing web pages exclusively is used, a case of searching for electronic documents that match search keywords from the database 200 (see FIG. 1) or the auxiliary storage device 114 (see FIG. 1) may be also used.

(4) In the above-described exemplary embodiments, although a function that assists the search is described as a function of the terminal 100 operated by the user, the function may be provided as a function of a processor that constitutes the database 200 or the web server 300. For example, the above is the case of a thin client system in which the terminal 100 operated by a user is used as an input and output device and a program is executed by a server.

(5) In the above-described exemplary embodiments, although the slope of the similarity of the electronic document to be browsed is required to be a condition of “continuous with a positive slope” between the two search keywords, the slope may be required to be equal to or higher than the condition. The equal here may include a case that even in a case where the average value of the similarity corresponding to the time of the second search is smaller than the average value of the similarity corresponding to the time of the first search, a difference between the two average values is within a predetermined threshold value. A positive slope is an example of equal to or higher.

(6) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
provide a user with information for assisting in search, in a case where candidates selected by the user from among a plurality of candidates that are search results are displayed in order, in a case where a predetermined condition is established for a tendency related to a plurality of operations of the user executed with respect to each search result.

2. The information processing apparatus according to claim 1, wherein the processor is configured to:
provide the user with the information for assisting in search, in a case where the predetermined condition is established among a tendency between a plurality of first operations executed with respect to results of a first search, a tendency between a plurality of first documents corresponding to the first operations, a tendency between a plurality of second operations executed with respect to results of a second search, which is executed subsequent to the first search, and a tendency between a plurality of second documents corresponding to the second operations.

3. The information processing apparatus according to claim 2,
wherein one of predetermined conditions is that a tendency, in which an interval between the operations for selecting a candidate to be displayed is shortened, is detected in both the first search and the second search.

4. The information processing apparatus according to claim 2,
wherein one of predetermined conditions is that similarities among a plurality of documents selected through the operations are equal between the first search and the second search.

5. The information processing apparatus according to claim 3,
wherein one of the predetermined conditions is that similarities among a plurality of documents selected through the operations are equal between the first search and the second search.

6. The information processing apparatus according to claim 1, wherein the processor is configured to:
estimate words in which a degree of attention is high based on user operations of a cursor for the displayed candidates and provide the words as the information for assisting in search.

7. The information processing apparatus according to claim 6, wherein the processor is configured to:
estimate, based on the words on which the cursor stayed and time during which the cursor stayed, a word in which the degree of attention is high.

8. The information processing apparatus according to claim 7, wherein the processor is configured to:
estimate, based on elapsed time from time the cursor left a document containing the word until the predetermined condition is established for each word on which the cursor stayed, a word in which the degree of attention is high.

9. A non-transitory computer readable medium storing a program causing a computer that displays candidates, in order, selected by a user from among a plurality of candidates that are search results, to implement:
a function of detecting an establishment of a predetermined condition for a tendency related to a plurality of operations of the user executed with respect to each search result; and
a function of providing the user with information for assisting in search, in a case where the establishment of the condition is detected.

10. An information processing method comprising:
detecting an establishment of a predetermined condition for a tendency related to a plurality of operations of a user executed with respect to each search result; and
providing the user with information for assisting in search, in a case where the establishment of the condition is detected.
